(19) United States
(12) Patent Application Publication
(10) Pub. No.: US 2003/0077052 A1
(43) Pub. Date: Apr. 24, 2003

(54) Laser module platform

(76) Inventors: William B. Joyce, Basking Ridge, NJ (US); YuZhong Dai, Orefield, PA (US)

Correspondence Address: Ms. Kyshon Rivers, Agere Systems, Inc., c/o Lucent Technologies, 600 Mountain Avenue, Room 3A 506, Murray Hill, NJ, 09794-0636, US

(21) Appl. No.: 10/001,355

(22) Filed: Oct. 23, 2001

(51) Int. Cl. G02B 6/42

(52) U.S. Cl. 385/92

(57) ABSTRACT

A laser module platform comprising a snout to support an optical fiber in alignment with a laser. The snout may form a seal with a case surrounding the platform. An optical fiber component is secured to the snout with one or more joints. The joints may be flanges, solder joints or welded joints.

### FIELD OF THE INVENTION

The invention relates to semiconductor lasers, and more particularly to laser mounting within a module.

### BACKGROUND OF THE INVENTION

A laser module includes a laser device surrounded by a protective case. A cross-sectional view of a typical prior art module 100 is depicted in FIG. 1. A laser 102 is positioned on a stack 120 attached to a platform 104, all within a case 106. Stack 116 may contain a plurality of components to position laser 102 in a desired location. A clip 108 is situated on platform 104 proximate to laser 102. Clip 108 supports an optical fiber 110 in a sleeve 114. Optical fiber 110 is in functional alignment with laser 102. Clip 108 is designed to allow alignment in the X, Y and Z directions, wherein the X-Y plane is perpendicular to the longitudinal direction of optical fiber 110. Case 106 has a snout through which optical fiber 110 in sleeve 114 (together optical component 116) is disposed. Solder 118 secures optical component 116 to a snout 112 of case 106. Soldering of sleeve 114 of optical component 116 to snout 112 produces a significant axial force on sleeve 114. The axial force may modify alignment of optical fiber 110 with laser 102. Proper alignment of optical fiber 110 with laser 102 is important for the performance of the device.

Typically the optical fiber is aligned with the laser prior to enclosure in the case. Subsequent testing, use and environmental conditions before and after case enclosure may cause misalignment. The enclosure and soldering processes may also cause misalignment. Furthermore, attachment of the module to other components, such as a base plate, may cause stresses that affect alignment. After case enclosure stress, relaxation may be performed, for example by heating to a temperature of about 100° C. and/or by temperature cycling. Stress relaxation, however, may not be entirely successful. Because the case is already in place, there is little more that can be done to reduce or eliminate unwanted stress.

Accordingly, there is a need for a laser module wherein adverse effects on alignment of the laser with the optical fiber produced by securing the sleeve to the module may be remedied or diminished prior to enclosure in a case. Furthermore, there is a need for a laser module that is less susceptible to adverse effects of testing, use and environmental conditions.

### SUMMARY OF THE INVENTION

The present invention may allow correction of adverse effects on laser alignment, caused by securing an optical fiber assembly in a laser module, prior to enclosure of the laser within a case.

Embodiments of the invention provide a laser module platform having a snout to support an optical fiber component in alignment with a laser. The snout can form a seal with a case surrounding the platform. The optical fiber component may be secured with one or more joints to the snout. The joints may be flanges, solder joints or welded joints. Because the snout is part of the platform, stress relaxation may be performed prior to the laser being enclosed in a case.

The invention further comprises a laser module having a platform and case wherein the platform includes a snout as described above. The support that may be provided by the platform's snout allows the case to be of a compliant material.

Still further, the invention includes a laser module having a compliant case, wherein the case may be made compliant by varying the case floor thickness.

### DESCRIPTION OF THE DRAWINGS

The invention is best understood from the following description when read with the accompanying drawings.

FIG. 1 depicts a cross-sectional view of a prior art laser module.

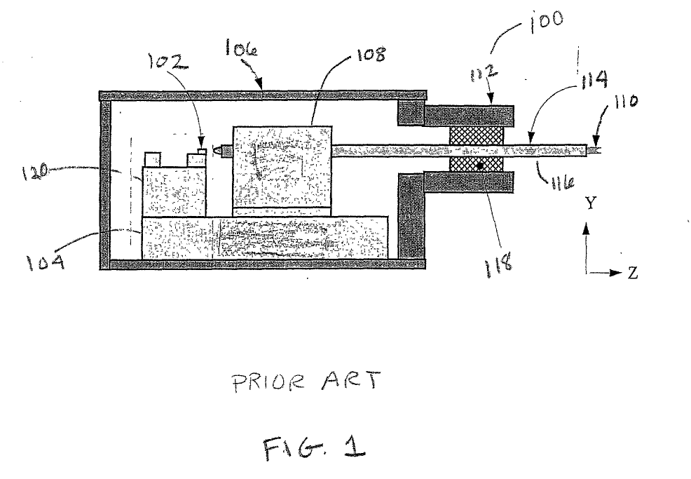

FIG. 2 depicts a cross-sectional view of a laser module according to a first illustrative embodiment of the invention.

FIG. 3 depicts a cross-sectional view of a laser module according to a second illustrative embodiment of the invention.

FIG. 4 depicts a cross-sectional view of a laser module according to a third illustrative embodiment of the invention.

FIG. 5 depicts a cross-sectional view of a laser module according to a fourth illustrative embodiment of the invention.

FIG. 6 depicts a top view of a case floor according to an illustrative embodiment of the invention.

FIG. 7 depicts a cross-sectional view of a laser module according to a fifth illustrative embodiment of the invention.

### DETAILED DESCRIPTION OF THE INVENTION

Embodiments of the invention include a laser module platform with a snout to support an optical fiber in alignment with a laser. The snout may form a seal with a case surrounding the platform. In prior art laser modules the snout is part of the surrounding case. By incorporating the snout into the platform rather than the case, laser-fiber alignment may be improved. Illustrative embodiments of the invention may permit alignment both prior to and after inserting the platform into a case.

Advantageously, embodiments of the invention may render the module less sensitive to distortion from being affixed to other components such as a base plate, pressure testing of the module, and baking and thermal cycling normally performed on a module after it is sealed in a case.

A further advantage is that the case may be more compliant than the platform, as it plays little or no role in alignment of the optical fiber with the laser. This allows the case to have properties that may not be possible with a more rigid case.

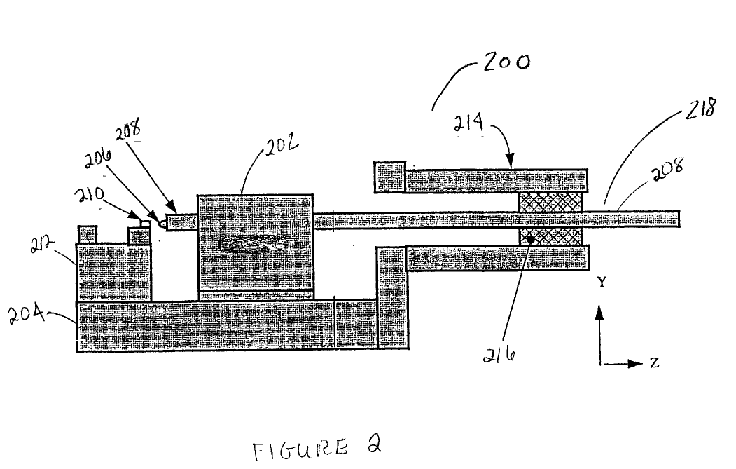

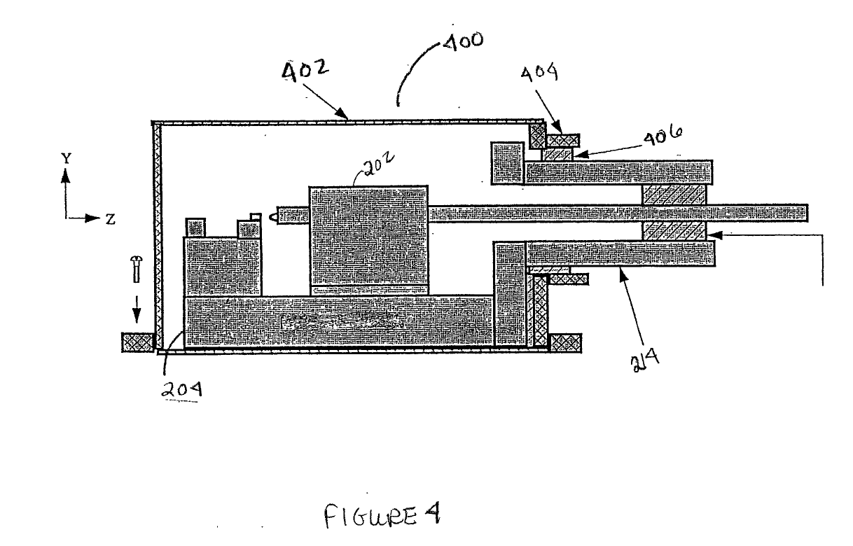

FIG. 2 is a cross-sectional view of a laser module portion 200 according to an illustrative embodiment of the invention. A clip 202 is provided on a platform 204. Clip 202 supports an optical fiber component 218, which would typically include an optical fiber 206 in a sleeve 208. Clip 202 also allows and maintains alignment of optical fiber 206 with laser 210. Laser 210 is supported by laser stack 212. Other support components may be used in place of clip 202, provided that they are compatible with the materials and operation of the device. Unlike prior art, laser modules, a snout 214 is part of platform 204, rather than part of a case. Snout 214 supports optical fiber component 218, and may provide a hermetic seal with a module case 402 as shown in FIG. 4 and described further below. Optical fiber component 218 is secured to snout 214 by one or more joints 216. Joint 216 may be, for example, a solder or welded joint.

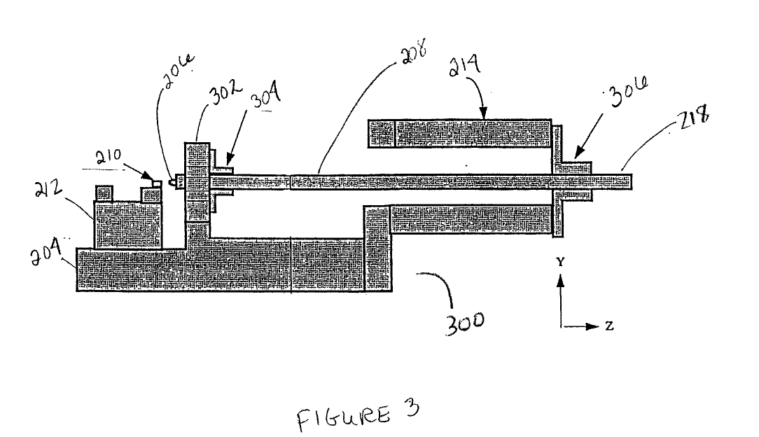

FIG. 3 depicts a cross-sectional view of a laser module portion 300 according to a further embodiment of the invention. In this embodiment, clip 202 is replaced by a post 302. A flange 304 secures optical fiber component 218 to post 302. As in the embodiment depicted in FIG. 2, platform 204 has a snout 214 that supports optical fiber component 218. In FIG. 3, optical fiber component 218 is secured to snout 214 by a flange 306. Flange 306 may be used in the post configuration of FIG. 3 or may be used with the clip configuration of FIG. 2. Likewise, joint 216, depicted in FIG. 2, may be used with the post configuration depicted in FIG. 3. Other types of support components may also be used in this flanged embodiment.

If the dimensions of the module are small enough, or optical fiber component 218 rigid enough, a support component such as clip 202, post 302 or the like may not be necessary.

FIG. 4 depicts a cross-sectional view of a laser module 400 according to an illustrative embodiment of the invention, which includes a platform 204 within a case 402. The structure depicted in FIG. 4 shows a clip 202, however, the case may be used with the post configuration of FIG. 3, or without any support component. Snout 214 may form a seal with case 402. In an illustrative embodiment, platform snout 214 is secured to case snout 404 by solder 406. Platform snout 214 may also be secured to case snout 404 by a flange (not shown) or other fastener or fastening material that is compatible with the laser module materials, design and operation.

The relocation of the snout from the case, as is typical in the prior art, to the platform, as is disclosed herein, permits at least two important advantages. Final alignment, stress relief and re-alignment may be done before access to the laser is denied by installation into the case. Additionally, because of the potentially stiff platform, the case may be made of a material that is more compliant than the platform, thus insulating the platform from any distortion of the case.

Additional embodiments of the invention include a laser module case comprising a floor, wherein at least a portion of the floor is more compliant than a platform within the case. The floor may be made compliant by selecting particular case floor parameters such as material and geometry.

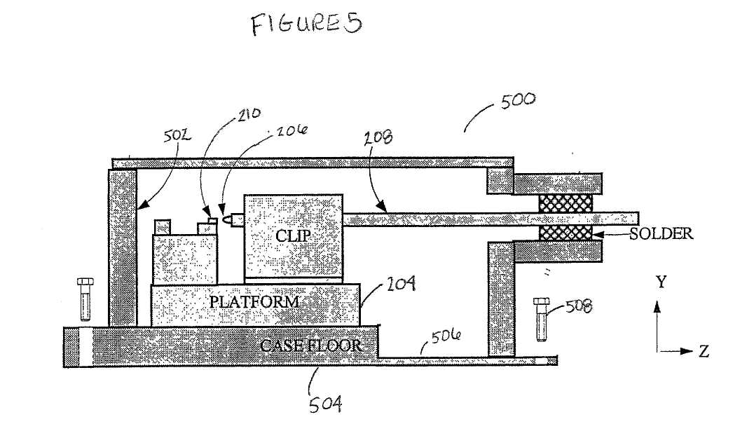

FIG. 5 depicts an illustrative embodiment of a laser module 500 having a case 502 with a case floor 504. The flexibility of case floor 504 may depend, for example, on the thickness, length or width of the floor. Environmental conditions, such as temperature, in which the laser module will be used also may affect floor flexibility. In FIG. 5, case floor 504 has a portion 506 that is thinner than the remainder of the floor to provide flexibility in portion 506. The thickness at which case floor 504 is sufficiently flexible, may depend on the length of the portion of case floor 504 that is not reinforced by other module components. A particular thickness may span the entire case floor or a portion thereof.

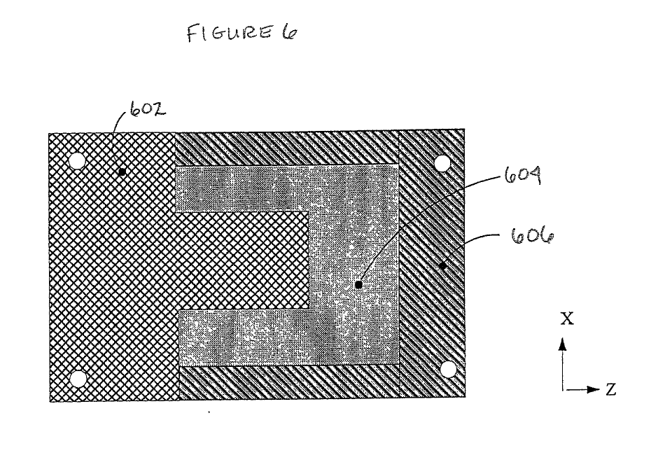

FIG. 6 depicts a top view of a case floor according to an illustrative embodiment of the invention. The floor is shown having a thick portion 602 and a thin portion 604 which would be more flexible than thick portion 602. The terms “thick” and “thin” merely imply relative thicknesses and are not associated with a finite quantity. Portion 606 may be either thin or thick depending on other parameters and use of the module. Varying thicknesses of the floor may be produced with a single component or by layering components to increase thickness.

By providing flexibility in case floor 504, alignment of fiber 206 with laser 210 may be less affected by actions taken on the module after the laser is enclosed in the case. For example, case floor 504 may be attached to a base by screws 508 which may cause distortion of the module. By providing a flexible case floor 504, the distortion is compensated for by case floor 504 instead of, for example, platform 204. By transferring the movement from platform 204 to case floor 504, laser 210 may be maintained in better alignment with fiber 206 than if platform 204 had deformed.

In a further illustrative embodiment of the invention, platform 204 is relatively small compared to case floor 504. The farther beyond platform 204 case floor 504 extends, the greater case floor 504's flexibility is. In an exemplary embodiment of the invention, platform 204 is about one-half the length of case floor 504.

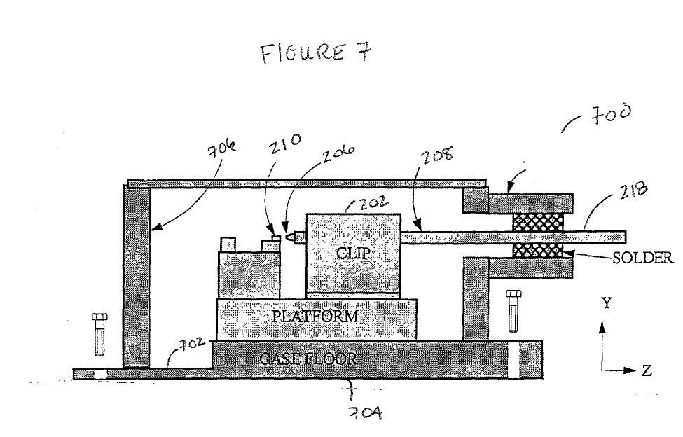

FIG. 7 depicts a laser module 700 according to a further illustrative embodiment of the invention. This embodiment shows a case 706 with a thinner portion 702 of case floor 704 on a side of the platform opposite to fiber 206. This may alleviate an additional source of misalignment caused by an optical fiber component 218 that is stiff enough to transmit mounting torsion to clip 202.

In addition to varying characteristics of the case floor to render it more compliant than the platform, platform characteristics may also be varied. For example, the platform may be made less flexible by use of particular materials and/or increasing its thickness. As long as the platform is less flexible than the case, regardless of whether the case was made more compliant or the platform was made more rigid, the case will accommodate torsion to which the module is subjected.

The invention further includes a laser module having a case wherein at least a portion of the floor is more compliant than a platform within the case.

In a broad embodiment, the invention includes a laser module having a platform and case, wherein the case is more compliant than the platform. Illustrative examples include a laser module having a case and a platform wherein the platform has any configuration described above. The case may be of a stiffer, or more compliant material than that of the platform, or may be of a material of comparable compliancy to the platform.

Still further, embodiments of the invention include a laser module having a compliant case, where a laser and optical fiber are maintained in alignment by one or more components other than the compliant case.

While the invention has been described by illustrative embodiments, additional advantages and modifications will occur to those skilled in the art. Therefore, the invention in its broader aspects is not limited to specific details shown and described herein. Modifications, for example, to the shape of the snout, the case floor geometry or the second component supporting the optical fiber, such as the clip or post, may be made without departing from the spirit and scope of the invention. Accordingly, it is intended that the invention not be limited to the specific illustrative embodiments but be interpreted within the full spirit and scope of the appended claims and their equivalents.

Claimed is:

1. A laser module platform comprising a snout to support an optical fiber component in alignment with a laser, wherein the snout forms a seal with a case surrounding the platform.

2. The laser module platform of claim 1 further comprising one or more joints to secure the optical fiber component to the snout.

3. The laser module platform of claim 2 wherein at least one joint is selected from the group consisting of solder joint, flange and welded joint.

4. The laser module platform of claim 1 further comprising a support structure disposed between the platform snout and the laser to provide additional support for the optical fiber.

5. The laser module platform of claim 4 wherein the optical fiber component is secured to the support structure by a flange.

6. A laser module comprising:
a platform;
wherein the platform has a snout to support an optical fiber in alignment with a laser; and
the snout can form a seal with a case surrounding the platform.

7. The laser module of claim 6 further comprising a case.

8. The laser module of claim 6 wherein the case comprises a material more compliant than the platform.

9. The laser module of claim 6 wherein the case comprises a snout into which the platform snout is disposed.

10. The laser module of claim 9 wherein one or more joints secure the case snout to the platform snout.

11. The laser module of claim 10 wherein at least one joint is selected from the group consisting of solder joint, welded joint and flange.

12. A laser module case comprising a floor, wherein at least a portion of the floor is more compliant than a platform within the case.

13. The laser module case of claim 12 wherein the compliant portion of the floor spans at least a portion of the floor between a case wall through which a fiber is disposed and the platform.

14. The laser module case of claim 12 wherein the compliant portion of the floor spans at least a portion of the floor between the platform and a case wall opposite to a case wall through which an optical fiber is disposed.

15. The laser module case of claim 12 wherein the compliant floor portion is thinner than an adjacent floor portion.

16. The laser module case of claim 12 wherein the compliant floor portion comprises a more compliant material than that of an adjacent floor portion.

17. The laser module case of claim 12 wherein the case floor is about twice the length of the platform.

18. A laser module having a case according to claim 12.

19. A laser module comprising a case and platform wherein the case is more compliant than the platform.
